(19) United States
(12) Patent Application Publication
(10) Pub. No.: US 2016/0202056 A1
(43) Pub. Date: Jul. 14, 2016

(54) LASER DEVICE AND HOLDING FIXTURE FOR ATTACHING A LASER DEVICE TO A HOLDING ELEMENT

(71) Applicant: HILTI AKTIENGESELLSCHAFT, Schaan (LI)

(72) Inventor: Alexander Senger, Buchs (CH)

(21) Appl. No.: 14/912,430

(22) PCT Filed: Aug. 19, 2014
(86) PCT No.: PCT/EP2014/067620

§ 371 Date: Feb. 17, 2016

(30) Foreign Application Priority Data
Aug. 21, 2013 (EP) 13181172.1

(51) Int. Cl. G01C 3/02; F16B 1/00

(52) U.S. Cl. CPC G01C 3/02; F16B 1/00; F16B 2001/0035

(57) ABSTRACT

A laser device 101 including a device housing 116, a measuring apparatus 117 that is at least partially arranged inside the device housing 116, and a first connector 106 that is connected the device housing 116 and that serves to connect the laser device 101 to a holding fixture 102. The first connector 106 has a first magnetic connection element 127, 128 and a first plug-in element 129.

The present invention relates to a laser device, to a holding fixture for attaching a laser device to a holding element as well as to a device system consisting of a laser device and a holding fixture.

The term “laser device” as set forth within the scope of the present invention encompasses all devices that use a measuring apparatus comprising optical or electro-optical components. Examples of laser devices are laser receivers, laser distance-measuring devices, point laser devices and/or line laser devices as well as rotary laser devices.

### BACKGROUND

The sturdiness of laser devices in case of a fall can be improved by using new materials, by combining various materials as well as by structural measures. In order to aim laser beams at a target point or a target area, it is often necessary to attach the laser device to a holding element. When it comes to holding elements, a distinction is made between tripods, mobile holding elements and stationary holding elements. Mobile holding elements are held in the hand of the user and can be moved in space. Examples of mobile holding elements are surveyor's staffs, leveling rods, plumb rods and telescopic rods. Stationary holding elements are elements in the place where the measurement taking place they actually have a different function and that are employed by the user as holding elements. Examples of stationary holding elements are wall rails, door or window frames and pipes. Holding elements with which the laser devices are attached to a tripod or to a mobile holding element have proven to be disadvantageous for the sturdiness of the laser devices.

German patent specification 10 2007 007 041 B3 discloses a tripod whose three legs can be rotated in order to convert the tripod into a holding fixture for attaching a laser device to a tubular holding element. The holding fixture comprises a base element, an attachment means to attach the holding fixture to the holding element, and a connecting means to connect the holding fixture to the laser device. The tripod legs are configured to be rotatable around an axis of rotation and they can be converted into an angular base element, whereby one tripod leg is oriented vertically while two tripod legs are oriented horizontally. The attachment means comprises an adapter having a V-shaped contact surface and an attachment strap. The adapter is positioned on the tubular holding element by means of the V-shaped contact surface, and then attached to the holding element by means of the attachment strap. Since the adapter is only needed for the attachment to a tubular holding element, the connection between the adapter and the tripod legs is configured in the form of a detachable magnetic connection. The vertically oriented tripod leg has at least one permanent magnet which, when in the connected state, is located opposite from a ferromagnetic area of the adapter. For purposes of connecting the holding fixture to a laser device, there is a threaded bolt on the uppermost horizontally oriented tripod leg that, together with a threaded hole on the underside of the laser device, forms a screwed connection.

The holding fixture diminishes the sturdiness of the laser device. Even though the magnetic connection between the adapter and the angled base element is severed in case the laser device is dropped, a force that is exerted onto the protruding angled element is transmitted via the screwed connection to the housing of the laser device. In actual practice, this means that cracks or other damage to the device housing occur in the area of the screwed connection in case the laser device is dropped.

U.S. Pat. No. 7,310,886 B discloses a known device system consisting of a laser device and a holding fixture for attaching the laser device to a magnetic holding element. The laser device comprises a housing, a measuring apparatus that is at least partially arranged inside the device housing, and a first connection means to connect the laser device to the holding fixture. The holding fixture has an L-shaped base element, an attachment means to attach the holding fixture to the holding element, and a second connection means to connect the holding fixture to the laser device. The first and second connection means are configured as a threaded hole and a threaded bolt that form a screwed connection when they are in the connected state. As an alternative, the base element is permanently connected to the housing of the laser device. The attachment means comprises at least one magnet, preferably two magnets, that are arranged in the base element.

The holding fixture diminishes the sturdiness of the laser device in case of a fall. Even though the magnetic connection between the holding fixture and the holding element is severed if the laser device is dropped, a force that is exerted onto the L-shaped base element is transmitted via the screwed connection to the housing of the laser device. Cracks or other damage can occur in the area of the screwed connection.

### SUMMARY OF THE INVENTION

It is an object of the present invention to improve a laser device and a holding fixture for attaching the laser device to a holding element in such a way as to reduce the risk of damage to the laser device in case it is dropped.

The present invention provides in the case of a laser device for the first connection means to have a first magnetic connection element and a first plug-in element. The first magnetic connection element forms a magnetic connection together with a second magnetic element of a holding fixture, and the first plug-in element forms a plug-and-socket connection together with a mating second plug-in element of the holding fixture. The plug-and-socket connection ensures that, when the laser device and the holding fixture are in the connected state, they are oriented in a defined position with respect to each other, and that the laser device is detachably connected to the holding fixture by means of the magnetic connection. In this context, the strength of the magnetic connection is set in such a way that, under normal operating conditions, the laser device is securely attached to a holding element, but so that the magnetic connection is severed if the laser device is exposed to a strong force.

A plug-and-socket connection constitutes a positive connection between a first and a second plug-in element, whereby the plug-in elements run along a plugging direction and create a positive connection in a plane perpendicular to the plugging direction. The plug-in elements are configured as cylindrical plugs with any desired cross-sectional surface and a mating socket; the plugging direction runs parallel to the cylinder axis of the plug-in elements. A magnetic connection is a non-positive connection between a first and a second magnetic connection element. Here, the magnetic connection between two permanent magnets or between one permanent magnet and an adhesion element can be made on the basis of a ferromagnetic material or a ferrimagnetic material.

Magnetization takes place when a material is exposed to a magnetic field. The magnetization creates in the material an additional magnetic field that is superimposed onto the external magnetic field. In this context, a distinction is made between materials having diamagnetic, paramagnetic and ferromagnetic properties. In the case of diamagnetic materials, the magnetization is oriented opposite from the external magnetic field, while in paramagnetic materials, the magnetization is oriented in the same direction as the external magnetic field. In ferromagnetic materials, the magnetization is likewise oriented in the same direction as the external magnetic field but, owing to a special interaction, namely, the exchange interaction, it is much more stable than in paramagnetic materials. Ferrimagnetic materials behave like weaker ferromagnetic materials and they are formed by superimposing two ferromagnetic materials having different orientations, whereby the magnetic properties do not completely compensate for each other.

The first plug-in element is preferably configured as a socket that is integrated into the housing of the laser device. It is advantageous for the first plug-in element to be configured as a socket, particularly for laser devices that are also used without a holding fixture. If the socket is integrated into the device housing, the first plug-in element does not protrude out of the device housing and therefore does not hinder the user during operation of the laser device.

In a first preferred embodiment, the first magnetic connection element is configured as a permanent magnet or else it has a permanent magnet. The permanent magnet forms a magnetic connection together with a second magnetic connection element of a holding fixture, whereby the second magnetic connection element is configured as a permanent magnet or as a ferromagnetic or ferrimagnetic adhesion element. Neodymium materials or ferrite materials can be employed as the materials for the permanent magnet. In contrast to ferrite magnets, neodymium magnets have the advantage of a higher adhesive force per volume or, at a given adhesive force, they require less space due to their smaller volume. Ferrite magnets are cost-efficient, they are temperature resistant up to approximately 250° C. (482° F.), and they are rust-proof. Neodymium magnets are well-suited wherever the available space is limited and/or if the laser device is supposed to be as lightweight as possible.

The permanent magnet is especially configured as a cylindrical permanent magnet or as a spherical permanent magnet, whereby the poles of the permanent magnets are arranged parallel to the plugging direction of the first plug-in element. Cylindrical permanent magnets are configured in the form of a cylinder having any desired cross-sectional surface and a given height. Examples of cylindrical permanent magnets are cuboids or cubes that have a square base as well as discs or rods that have a circular base. The permanent magnet can also be configured as a horseshoe magnet that is a curved rod magnet. The shape of the permanent magnet is adapted to the circumstances of the laser device and to the space available.

When it comes to cylindrical permanent magnets, the poles are arranged on the base and top surfaces of the cylinder and the permanent magnet is magnetizable vertically (axial magnetization); in the case of a spherical permanent magnet, the poles are arranged opposite from each other horizontally. The arrangement of the poles of the permanent magnet parallel to the plugging direction has the advantage that the adhesive force between the magnetic connection elements changes as a function of the distance and it is at its greatest when the distance is as small as possible. The structure of the magnetic connection allows the laser device to be connected in a defined position to a holding fixture. The magnetic connection displays a maximum force when the plug connection is established and it affixes the laser device and the holding fixture in the desired position.

Especially preferably, the first magnetic connection element additionally has a ferromagnetic or ferrimagnetic element. The ferromagnetic or ferrimagnetic element surrounds the permanent magnet and changes the magnetic field of the permanent magnet. In this context, the ferromagnetic or ferrimagnetic element is arranged in such a way that the magnetic field lines are oriented towards the second magnetic connection element and the adhesive force is strengthened. One example is an axially magnetized disc magnet that is surrounded by a steel pot, whereby the disc magnet is not shielded in the contact area to the adhesion element.

In a second preferred embodiment, the first magnetic connection element is configured as a ferromagnetic or ferrimagnetic adhesion element. Together with a second magnetic connection element of a holding fixture, the adhesion element forms a magnetic connection, whereby the second magnetic connection element is configured as a permanent magnet or it has a permanent magnet.

Especially preferably, the first connection means has two first magnetic connection elements and/or two first plug-in elements. A first connection means having two first magnetic connection elements has the advantage that the arrangement of the magnetic connection elements can be optimized in terms of the center of gravity of the device. In order to ensure that the laser device can only be connected to a holding fixture in the desired orientation, the two first plug-in elements can be configured so as to be of different sizes or else they can have differently shaped cross sections.

In a preferred variant, the housing of the laser device is configured so as to consist of two parts, a base housing and a protective housing surrounding the base housing, whereby the first connection means is arranged in the protective housing. The two-part configuration of the device housing consisting of a base housing and a protective housing has the advantage that the first connection means that is needed to connect the laser device to a holding fixture can be retrofitted onto conventional laser devices. Moreover, the protective housing can be optimized with an eye towards being very sturdy in case it is dropped. The protective housing can have protruding shock-absorbing elements that are preferably formed at the transitions of the surfaces of the protective housing in the form of edges or corners. The protective housing is configured in such a way that, even without a holding fixture, the laser device can be used with the protective housing. Laser receivers and laser distance-measuring devices are devices that lend themselves for having a two-part configuration of the housing.

In an alternative variant, the housing of the laser device is configured in one part. The one-part configuration of the device housing has the advantage that fewer components are needed and that the connection between the laser device and the holding fixture has a simpler configuration.

When it comes to the holding fixture for attaching a laser device, it is provided according to the invention for the second connection means to have a second magnetic connection element and a second plug-in element. Together with a first magnetic connection element of a laser device, the second magnetic connection element forms a magnetic connection, and, together with a mating first plug-in element of the laser device, the second plug-in element forms a plug-and-socket connection.

Preferably, the second plug-in element of the second connection means is configured as a plug. It is advantageous to configure the second plug-in element of the holding fixture as a plug and the first plug-in element of the laser device as a mating socket for laser devices that are also used without a holding fixture. The holding fixture is only used together with a connected laser device, so that protruding plugs on the holding device do not pose a problem.

In a first preferred embodiment, the second magnetic connection element is configured as a ferromagnetic or ferrimagnetic adhesion element. Together with a first magnetic connection element of a laser device, the adhesion element forms a magnetic connection, whereby the first magnetic connection element is configured as a permanent magnet or else it has at least one permanent magnet.

In a second preferred embodiment, the second magnetic connection element is configured as a permanent magnet or it has a permanent magnet. Together with a first magnetic connection element of a laser device, the permanent magnet forms a magnetic connection, whereby the first magnetic connection element is configured as a permanent magnet or else as a ferromagnetic or ferrimagnetic adhesion element.

Especially preferably, the second magnetic connection element additionally has a ferromagnetic or ferrimagnetic element. The ferromagnetic or ferrimagnetic element surrounds the permanent magnet and changes the magnetic field of the permanent magnet. The adhesive force of the permanent magnet can be strengthened by means of this additional element.

Preferably, the second connection means has two second magnetic connection elements and/or two second plug-in elements. A second connection means having two second magnetic connection elements has the advantage that the arrangement of the magnetic connection elements can be optimized in terms of the center of gravity of the device. In the case of a second connection means having two plug-in elements, the two plug-in elements can be configured so as to be of different sizes or to have different cross-sectional shapes in order to connect the holding fixture to a laser device in the desired orientation.

According to the invention, in the case of the device system, it is provided for the first connection means to have a first magnetic connection element and a first plug-in element and for the second connection means to have a second magnetic connection element and a second plug-in element, whereby, when the laser device and the holding fixture are in the connected state, the first and second plug-in elements form a plug-and-socket connection, while the first and second magnetic connection elements form a magnetic connection. The laser device is detachably connected to the holding fixture via the combined plug-and-socket and magnetic connection. The plug-and-socket connection creates a positive fit and ensures a defined orientation of the laser device relative to holding fixture. The strength of the magnetic connection is set in such a way that, under normal operating conditions, the laser device is securely attached to a holding element but that the magnetic connection is severed if an excessive external force is exerted on the laser device. The sturdiness of the laser device against falls is enhanced in that the magnetic connection is severed if a critical limit value is exceeded due to the exertion of an external force.

The combined plug-and-socket and magnetic connection of the device system according to the invention can preferably be used for laser devices whose housing is very sturdy due to the use of modern materials, due to a combination of various materials or due to structural measures. The critical connection between the laser device and the holding fixture is severed if the device is dropped and the elastically deformable device housing dissipates impact energy and subsequently returns to its undeformed shape.

Preferably, the maximum force of the magnetic connection between the magnetic connection elements is present when the plug-and-socket connection between the plug-in elements is established. The magnetic connection elements of the first and second connection means are arranged in such a way that the maximum force is present when the plug-and-socket connection is established. This arrangement has the advantage that the laser device and the holding fixture are affixed in a precisely defined position by means of the magnetic connection elements. When the plug-and-socket connection is established, the laser device and the holding fixture are pulled by the magnetic force into the desired position.

Especially preferably, when the plug-and-socket connection is established, the first and second connection means connect a first contact surface of the laser device to a second contact surface of the holding fixture. Since a first contact surface of the laser device comes to rest against a second contact surface of the holding fixture when the plug-and-socket connection is established, the connected state between the laser device and the holding fixture is precisely defined. The magnetic connection, which exhibits its maximum force when the plug-and-socket connection is established, affixes the laser device and the holding fixture in the area where the contact surfaces come to rest against each other.

Embodiments of the invention will be described below with reference to the drawing. The drawing does not necessarily depict the embodiments true-to-scale, but rather, the drawing—where necessary for the sake of elucidation—is shown in schematic and/or in slightly distorted form. Regarding any expansion of the teaching that can be gleaned directly from the drawing, reference is hereby made to the pertinent state of the art. Here, it has to be taken into account that many modifications and changes relating to the shape and to the detail of an embodiment can be made without deviating from the general idea of the invention. The features of the invention disclosed in the description, in the drawing as well as in the claims can be essential for the refinement of the invention individually as well as in any desired combination. Moreover, all combinations of at least two of the features disclosed in the description, in the drawing and/or in the claims fall within the scope of the invention. The general idea of the invention is not limited to the exact form or detail of the preferred embodiment shown and described below nor is it limited to a subject matter that would be limited in comparison to the subject matter put forward in the claims. At given rated ranges, values that fall within the specified limits are also to be disclosed as limit values and to be used and claimed as desired. For the sake of clarity, identical or similar parts or else parts with an identical or similar function are designated by the same reference numerals below.

### BRIEF DESCRIPTION OF THE DRAWINGS

The following is shown:

FIGS. 1A, 1B: a first embodiment of a device system according to the invention, comprising a laser receiver and a holding fixture for attaching the laser device to a surveyor's staff;

FIG. 2: a second embodiment of a device system according to the invention, comprising a laser receiver and a holding fixture for attaching the laser device to a holding element;

FIG. 3: a third embodiment of a device system according to the invention, comprising a laser distance-measuring device and a holding fixture configured as a tripod adapter for attaching the laser distance-measuring device to a tripod;

FIGS. 4A, 4B: the tripod adapter (FIG. 4A) and the laser distance-measuring device (FIG. 4B) of FIG. 3 in detail;

FIGS. 5A, 5B: a fourth embodiment of a device system according to the invention, comprising a self-leveling point laser device and a holding fixture for attaching the point laser device to a holding element;

FIG. 6: a fifth embodiment of a device system according to the invention, comprising a rotary laser device and a holding fixture for attaching the rotary laser device to a tripod; and

FIGS. 7A-7C: several variants of a plug-and-socket connection and a magnetic connection.

### DETAILED DESCRIPTION

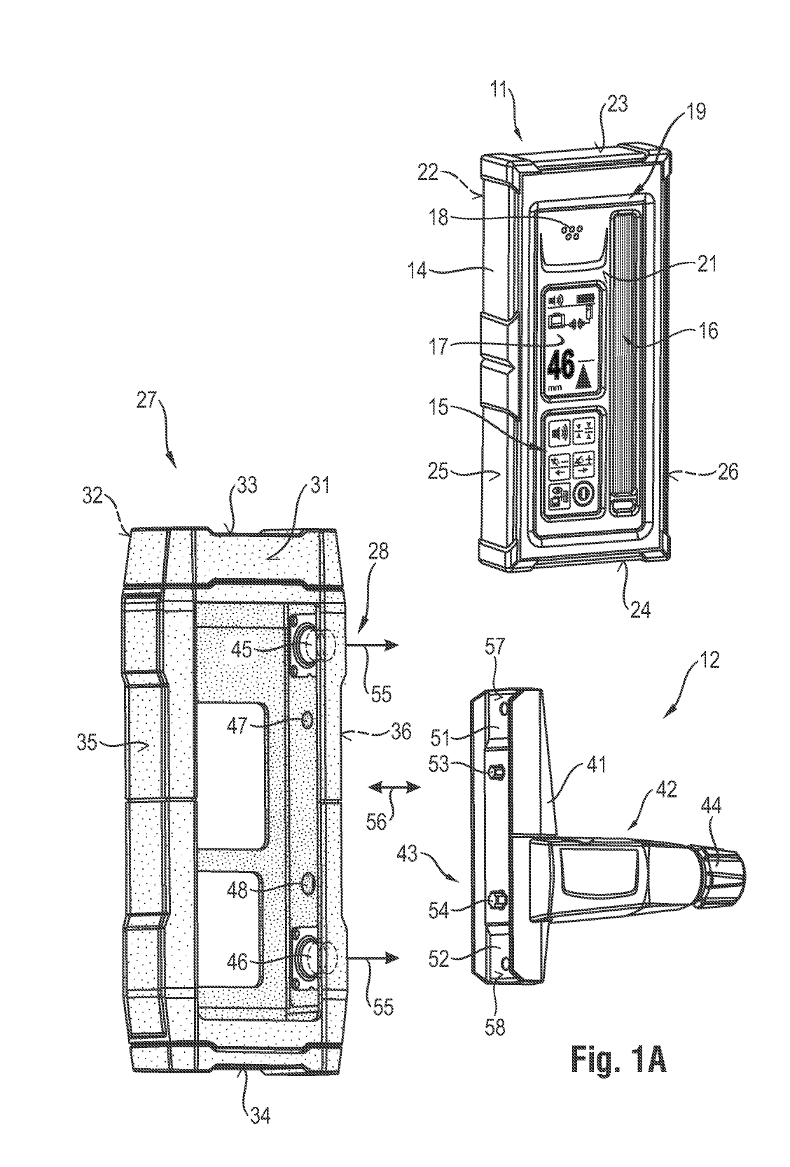

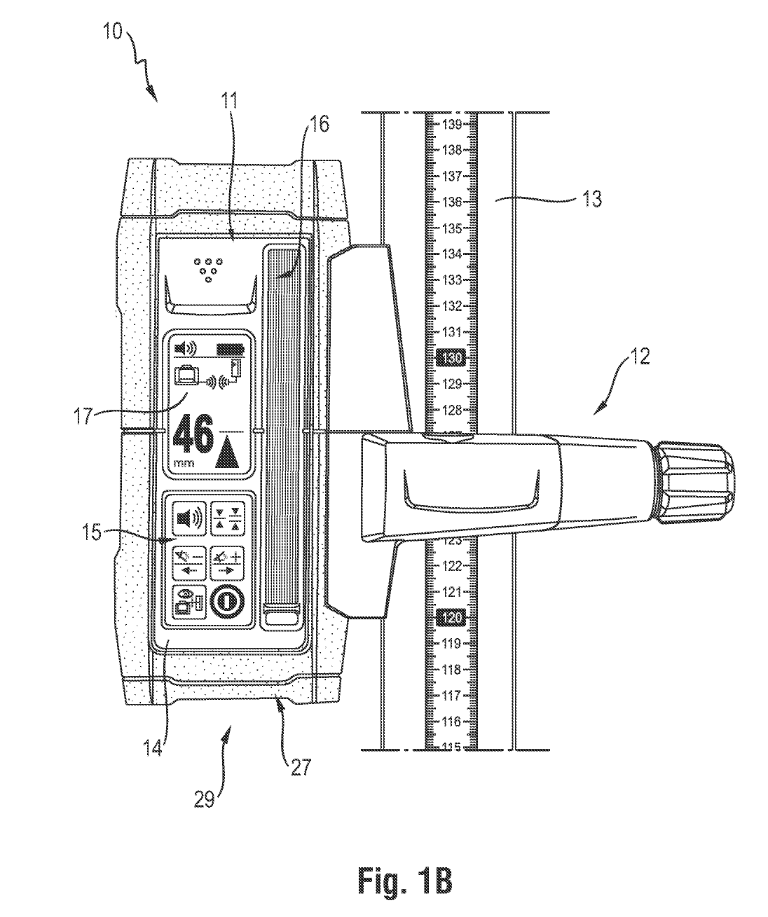

FIGS. 1A, 1B show a first embodiment of a device system 10 according to the invention, consisting of a laser device according to the invention configured as a laser receiver 11 and a holding fixture 12 according to the invention for attaching the laser receiver 11 to an elongated holding element that is configured as a surveyor's staff 13. Here, FIG. 1A shows the laser receiver 11 and the holding fixture 12 in the unconnected state, while FIG. 1B shows the laser receiver 11 that is attached to the surveyor's staff 13 by means of the holding fixture 12.

The laser receiver 11 is an accessory employed for point laser, line laser or rotary laser devices which are used with laser beams that are hard to see in order to improve the visibility of the laser beams. In this context, the user can hold the laser receiver 11 directly in the laser beam, or else the laser receiver 11 is attached to a holding element. When it comes to the holding elements, a distinction is made between tripods, mobile holding elements and stationary holding elements. Stationary holding elements are elements used in the place where the measurement is taking place that actually have a different function and that are employed by the user as holding elements such as, for instance, wall rails, door or window frames and pipes. Mobile holding elements are held in the hand of the user and can be moved in space, for example, surveyor's staffs, leveling rods and plumb rods. In this context, the mobile holding elements are configured as elongated holding elements and their cross sections are much smaller than their dimensions in the lengthwise direction.

The laser receiver 11 comprises a base housing 14, an operating unit 15 for operating the laser receiver 11, a detector 16 to detect a laser beam, a display 17 and an acoustic indicator 18. The electric components of the laser receiver 11 are also referred to as the measuring apparatus 19. The measuring apparatus 19 is at least partially surrounded by the base housing 14 or else it is integrated into the base housing 14. The base housing 14 has a front surface 21, a rear surface 22 that is located opposite from the front surface 21, a top 23, a bottom 24 that is located opposite from the top, and two side surfaces 25, 26.

The operating unit 15, the detector 16, the display 17 and the acoustic indicator 18 are arranged on the front surface 21 of the base housing 14. In order to make it very convenient for the user to operate the laser receiver 11, the front surface 21 and the rear surface 22 are the two largest surfaces of the device housing 14, which has a longer side (length) and a shorter side (width). The two side surfaces 25, 26 adjoin the longer side of the front surface 21 and they are defined by the length and the depth of the base housing 14.

The laser receiver 11 additionally comprises a protective housing 27 that surrounds the base housing 14 when in the connected state (FIG. 1B), and a first connection means 28 to connect the laser receiver 11 to the holding fixture 12. Together, the base housing 14 and the protective housing 27 are referred to as the device housing 29 of the laser receiver 11. The two-part configuration of the device housing 29, consisting of the base housing 14 and the protective housing 27, has the advantage that the holding fixture 12 according to the invention can be retrofitted onto conventional laser receivers.

Like the base housing 14, the protective housing 27 has a front surface 31, a rear surface 32 that is located opposite from the front surface 31, a top 33, a bottom 34 that is located opposite from the top, and two side surfaces 35, 36. When in the connected state, the front and rear surfaces 31, 32, the top and bottom 33, 34 and the side surfaces 35, 36 of the protective housing 27 are located opposite from the corresponding housing surfaces 21-26 of the base housing 14. The protective housing 27 can be made of an elastomeric plastic or of a thermoplastic-elastomeric plastic. If the laser receiver 11 is dropped, the protective housing 27 protects the laser receiver 11 against damage. The material properties of the plastic are selected in such a way that, if the device is dropped, the protective housing 27 will deform elastically and subsequently return to its undeformed shape.

The protective housing 27 can have protruding shock-absorbing elements that are preferably formed at the transitions of the housing surfaces 31-36 of the protective housing 27 in the form of edges or corners. Protective elements can also be provided on the base housing 14 and they protect the laser receiver 11 if the laser receiver 11 is being held by the user in the laser beam without the protective housing 27 or holding fixture 12. In this context, the protective housing 27 is configured in such a way that the laser receiver 11 can be used with the protective housing 27, even without the holding fixture 12.

The holding fixture 12 comprises a base element 41, an attachment means 42 that is connected to the base element 41 and that serves to attach the holding fixture 12 to the surveyor's staff 13, and a second connection means 43 that is connected to the base element 41 and that serves to connect the holding fixture 12 to the laser receiver 11. The holding fixture 12 rigidly connects the laser receiver 11 to the surveyor's staff 13, that is to say, when in the connected state, the laser receiver 11 is not moveable relative to the surveyor's staff 13. The attachment means 42 is configured, for instance, as a clamping means equipped with flat clamping jaws which are adjusted by means of an adjustment element 44 until the clamping jaws are in contact with the side surfaces of the surveyor's staff 13 and the holding fixture 12 is clamped onto the surveyor's staff 13.

The laser receiver 11 and the holding fixture 12 are detachably connected to each other by a first and second connection means 28, 43. The connection between the laser receiver 11 and the holding fixture 12 is configured as a combined magnetic and plug-and-socket connection, that is to say, the laser receiver 11 and the holding fixture 12 are connected to each other via a magnetic connection and additionally via a plug-and-socket connection. The plug-and-socket connection ensures that, when the laser receiver 11 and the holding fixture 12 are in the connected state, they are arranged in a defined position relative to each other. The laser receiver 11 and the holding fixture 12 are detachably connected to each other by means of the magnetic connection. In this context, the strength of the magnetic connection is set in such a way that, during operation, the laser receiver 11 is securely attached to the surveyor's staff 13 by means of the holding fixture 12 and the magnetic connection is severed if a strong force is exerted on the laser receiver 11.

The first connection means 28 of the laser receiver 11 comprises two first magnetic connection elements 45, 46 and two first plug-in elements 47, 48. The second connection means 43 of the holding fixture 12 comprises two second magnetic connection elements 51, 52 and two second plug-in elements 53, 54. When the first and second first plug-in elements 47, 48, 53, 54 are in the connected state, they form the plug-and-socket connection, while the first and second magnetic connection elements 45, 46, 51, 52 form the magnetic connection. By means of the plug-in elements 47, 48, 53, 54, the laser receiver 11 and the holding fixture 12 are oriented in a defined position relative to each other and the magnetic connection elements 45, 46, 51, 52 ensure that the laser receiver 11 and the holding fixture 12 are detachably affixed in this position. Here, the adhesive force of the magnetic connection is set in such a way that, under normal operating conditions, the laser receiver 11 is securely attached to the surveyor's staff 13 but so that the magnetic connection is severed if a strong force is exerted on the laser receiver 11.

The first magnetic connection elements of the laser receiver 11 are configured as permanent magnets 45, 46 which are arranged in the side surface 36 of the protective housing 27, while the second magnetic connection elements of the holding fixture 12 are configured as ferromagnetic elements 51, 52 which are located opposite from the permanent magnets 45, 46 when in the connected state. As an alternative to the embodiment shown in FIGS. 1A, 1B, the permanent magnets 45, 46 can be provided on the holding fixture 12 while the ferromagnetic elements 51, 52 are provided on the laser receiver 11, or else the laser receiver 11 and the holding fixture 12 each have a permanent magnet 45, 46 and a ferromagnetic adhesion element 51, 52.

The permanent magnets 45, 46 are configured as circular cylinders having circular base and cover surfaces and a given height. The N, S poles of the permanent magnets 45, 46 are arranged on the base and cover surfaces, that is to say, the permanent magnets 45, 46 are magnetized vertically along a magnetization direction 55 that runs parallel to the longitudinal axis. The height of the permanent magnets 45, 46 is smaller than the diameter and preferably amounts to approximately 50% of the diameter. When in the connected state, the ferromagnetic adhesion elements 51, 52 are located opposite from the permanent magnets 45, 46; the adhesive force between the magnetic connection elements 45, 46, 51, 52 increases as the distance between the permanent magnets 45, 46 and the adhesion elements 51, 52 diminishes.

The first plug-in elements of the laser receiver 11 are configured as cylindrical sockets 47, 48 that are integrated into the side surface 36 of the protective housing 27, while the second plug-in elements of the holding fixture 12 are configured as cylindrical plugs 53, 54 that mate with the sockets 47, 48. The plug-in elements 47, 48, 53, 54 are moved along a plugging direction 56 that runs parallel to the cylinder axis or longitudinal axis of the plug-in elements, and they form a positive connection in a plane perpendicular to the plugging direction 56. In order to ensure that the laser receiver 11 and the holding fixture 12 can only be connected to each other in the desired orientation, the two plugs 53, 54 can be configured so as to be of different sizes and/or to have cross sections of a different shape. FIG. 1A shows two differently sized plugs 53, 54 having the same cruciform cross section.

The holding fixture 12 is moved together with the plugs 53, 54 along the plugging direction 56 into the sockets 47, 48 of the laser receiver 11 until the side surface 36 of the protective housing 27 comes to rest against the ferromagnetic adhesion elements 51, 52. The side surface 36 of the protective housing 27 is adapted to the surfaces 57, 58 of the ferromagnetic adhesion elements 51, 52. In order to ensure a defined contact, the plugs 53, 54 are configured so as to be shorter than the sockets 47, 48 and, when the laser receiver 11 and the holding fixture 12 are in the connected state, that is to say, when the plug-and-socket connection of the plug-in elements 47, 48, 53, 54 is established, a narrow gap is formed in the axial direction (along the plugging direction 56). The plug-and-socket connection is referred to as being established when the plug-in elements 47, 48, 53, 54 form a positive connection perpendicular to the plugging direction 56 and the laser receiver 11 and the holding fixture 12 were moved towards each other along the plugging direction 56 until they have come into contact.

The maximum force of the magnetic connection is present when the plug-and-socket connection of the first and second plug-in elements 47, 48, 53, 54 is established. When the plug-and-socket connection is established, the distance between the permanent magnets 45, 46 and the adhesion elements 51, 52 is at its smallest while the adhesive force between the magnetic connection elements 45, 46, 51, 52 is at its greatest. The permanent magnets 45, 46 are arranged in the protective housing 27 and do not have any direct contact with the ferromagnetic adhesion elements 51, 52 in order not to mechanically stress the permanent magnets 45, 46. Since conventional permanent magnets are sensitive to mechanical stresses, the service life of the permanent magnets 45, 46 in increased by the physical separation, and the reproducibility of the magnetic adhesive forces is improved. Moreover, the permanent magnets 45, 46 are protected against corrosion.

The two permanent magnets 45, 46 that are arranged in the side surface 36 of the protective housing 27 are arranged outside of the center of gravity of the laser receiver 11. In this context, one permanent magnet 45 is arranged above the center of gravity while the other permanent magnet is arranged below the center of gravity. This arrangement of one permanent magnet 45 above the center of gravity reduces the risk that the laser receiver 11 will tilt. A typical malfunction occurs in actual practice when the laser receiver 11 is attached to the surveyor's staff 13 and the tip of the surveyor's staff 13 strikes a substrate. Since the laser receiver 11 is attached to the side of the surveyor's staff 13, a torque is generated that causes the lower edge of the holding fixture 12 to tilt at the lower adhesion element 58. The longer the lever formed by the upper permanent magnet 45 together with the lower edge of the lower adhesion element 58, the greater the critical limit that the torque has to exceed before the laser receiver 11 tilts. The use of two permanent magnets 45, 46 is advantageous, for instance, when the laser receiver 11 with the surveyor's staff 13 is being transported horizontally.

The laser receiver 11 is attached to the surveyor's staff 13 by means of the holding fixture 12. Not only the surveyor's staff 13 but also the holding fixture 12 can be attached to all elongated holding elements. Elongated holding elements have a diameter that is smaller than the length and they can be configured in the form of rods, tubes or profiles. Rod-like holding elements have a closed cross section, tubular holding elements have a hollow, closed cross section, and profile-shaped holding elements have an open cross section. The contact surface can be configured so as to be flat or else V-shaped. A flat contact surface is suitable for holding elements having a rectangular cross section, while a V-shaped contact surface is particularly well-suited for holding elements having a round or rounded-off cross section.

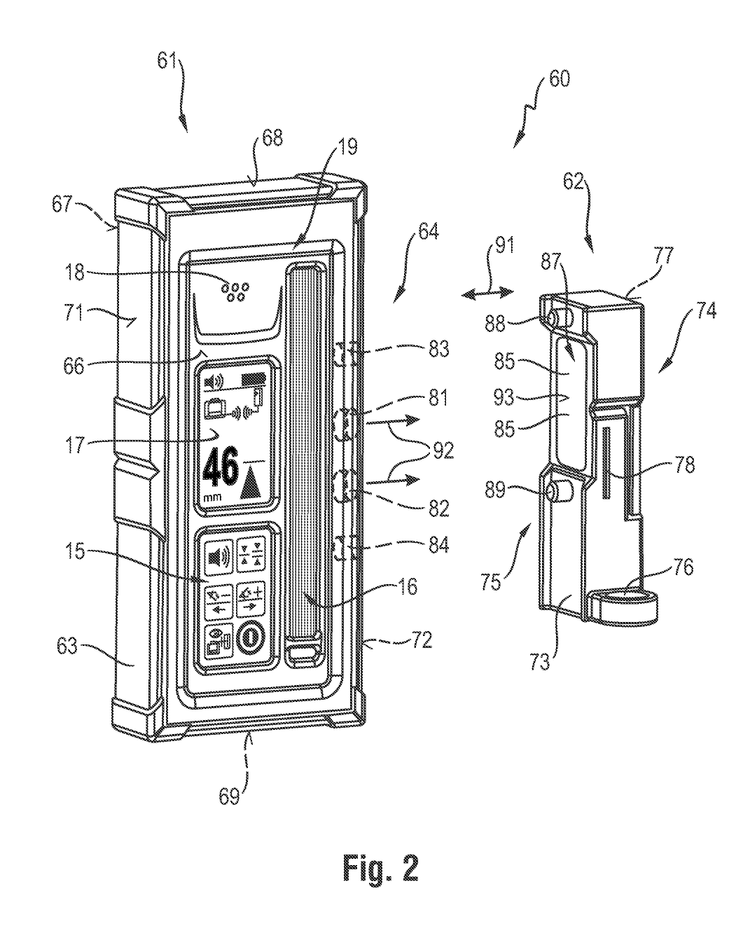

FIG. 2 shows a second embodiment of a device system 60 according to the invention, consisting of a laser receiver 61 according to the invention and a holding fixture 62 according to the invention for attaching the laser receiver 61 to an elongated holding element, for instance, a tube.

The laser receiver 61 comprises a device housing 63, the measuring apparatus 19 and a first connection means 64 that is connected to the device housing 63 and that serves to connect the laser receiver 61 to the holding fixture 62. The laser receiver 61 differs from the laser receiver 11 of the device system 10 in that the device housing 63 is configured in one part, in contrast to the two-part device housing 29 of the laser receiver 61. The device housing 63 has a front surface 66, a rear surface 67 that is located opposite from the front surface, a top 68, a bottom 69 that is located opposite from the top, and two side surfaces 71, 72.

The holding fixture 62 comprises a base element 73, an attachment means 74 to attach the holding fixture 62 to the holding element and a second connection means 75 to connect the holding fixture 62 to the laser receiver 61; additionally, the holding fixture 62 comprises a leveling sensor 76 with which the holding fixture 62 can be oriented so as to be plumb. The laser receiver 61 is rigidly connected to the holding element by means of the holding fixture 62, that is to say, when the laser receiver 61 is in the connected state, it is not moveable relative to the holding element.

The attachment means 74 of the holding fixture 62 has a contact surface 77 and a belt that can be pulled through a belt fitting 78 in the base element 73. As an alternative or in addition, magnets can be arranged in the base element 73, so that the holding fixture 62 can be attached via the contact surface 77 to a magnetically configured holding element. As shown in FIG. 2, the contact surface 77 can be configured so as to be flat or, as an alternative, so as to be V-shaped. A flat contact surface is suitable for holding elements having a rectangular cross section, whereas a V-shaped contact surface is particularly well-suited for holding elements having a round or rounded-off cross section.

The first connection means 64 of the laser receiver 61 has two first magnetic connection elements configured as permanent magnets 81, 82, and two first plug-in elements configured as sockets 83, 84. The second connection means 75 of the holding fixture 62 has two second magnetic connection elements 85, 86 that are integrated into a ferromagnetic adhesion element 87, and two second plug-in elements 88, 89 configured as plugs. When the first and second plug-in elements 83, 84, 88, 89 are in the connected state, they form the plug-and-socket connection, while the first and second magnetic connection elements 81, 82, 85, 86 form the magnetic connection. The holding fixture 62 is moved together with the plugs 88, 89 into the sockets 83, 84 of the laser receiver 11 along a plugging direction 91 that runs parallel to the longitudinal axis of the plug-in elements until the side surface 72 of the device housing 63 comes to rest against the ferromagnetic adhesion element 87.

Like the permanent magnets 45, 46 of the laser receiver 11, the permanent magnets 81, 82 are configured so as to be circular-cylindrical, and they are axially magnetized vertically along a magnetization direction 92 that runs parallel to the cylinder axis. The side surface 72 of the device housing 63 is adapted to the surface 93 of the ferromagnetic adhesion element 87. The connection elements 81-84 of the first connection means 64 are arranged in such a way that the magnetization direction 92 of the permanent magnets 81, 82 runs parallel to the plugging direction 91 of the plug-in elements 83, 84.

When the permanent magnets 81, 82 are in the connected state, they are located opposite from the ferromagnetic adhesion element 87. The adhesive force between the magnetic connection elements increases as the distance between the permanent magnets 45, 46 and the adhesion element 87 diminishes. The maximum force of the magnetic connection is present when the plug-and-socket connection is established, and the first and second connection means 64, 75 connect the side surface 72 of the device housing 63 to the surface 93 of the ferromagnetic plate 87. The side surface 72 of the device housing 63 is designated as the first contact surface of the laser device 61, while the surface 93 is designated as the second contact surface of the holding fixture 62.

As an alternative, the permanent magnets 81, 82 can be provided on the holding fixture 62 while the ferromagnetic adhesion element 87 is provided on the laser receiver 61, or else the laser receiver 61 and the holding fixture 62 each have a permanent magnet 81, 82 and a ferromagnetic adhesion element 87. If the permanent magnets 81, 82 are provided on the holding fixture 62, the device system 60 can be attached to a magnetic holding element. The permanent magnets 81, 82 merely need to generate the requisite adhesive force to securely attach the laser receiver 61 and the holding fixture 62. As shown in FIG. 2, the plugs 88, 89 can be arranged on the holding fixture 62 or alternatively, they can be arranged on the laser receiver 61. Since the laser receiver 61 is also used without the holding fixture 62, the version shown in FIG. 2 has the advantage that the plugs 88, 89 do not protrude from the device housing 63 of the laser receiver 61 and do not get in the way of the user.

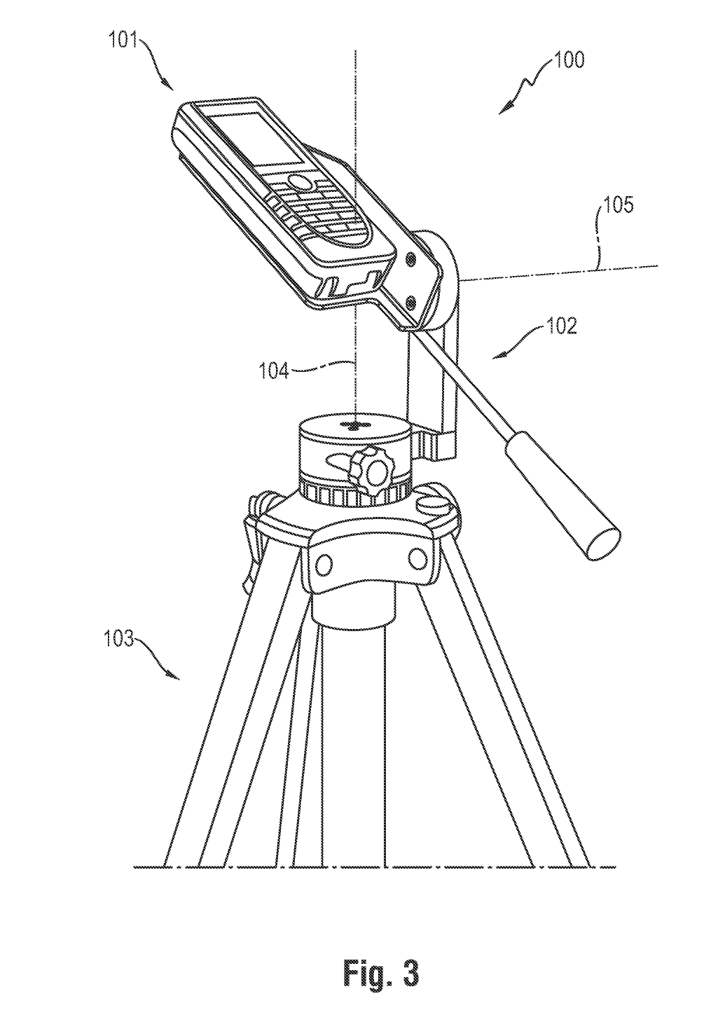

FIG. 3 shows a third embodiment of a device system 100 according to the invention, consisting of a laser device according to the invention configured as a laser distance-measuring device 101, and a holding fixture 102 according to the invention configured as a tripod adapter for attaching the laser distance-measuring device 101 to a tripod 103.

The laser distance-measuring device 101 is arranged on the tripod 103 by means of the tripod adapter 102. In the embodiment shown in FIG. 3, the tripod adapter 102 can be rotated around two axes that are perpendicular to each other, namely, a vertical rotational axis 104 and a horizontal tilting axis 105. The laser distance-measuring device 101 is connected to the tripod 103 via the tripod adapter 102 that—relative to the tripod 103—allows a rotational movement around the vertical rotational axis 104 as well as a pivoting movement around the tilting axis 105. Further adjustment can be carried out, for example, by means of a height-adjustable tripod 103. In this context, the laser distance-measuring device 101 can be arranged in any desired position, so that the user can aim the laser beam at any target point in order to measure the distance.

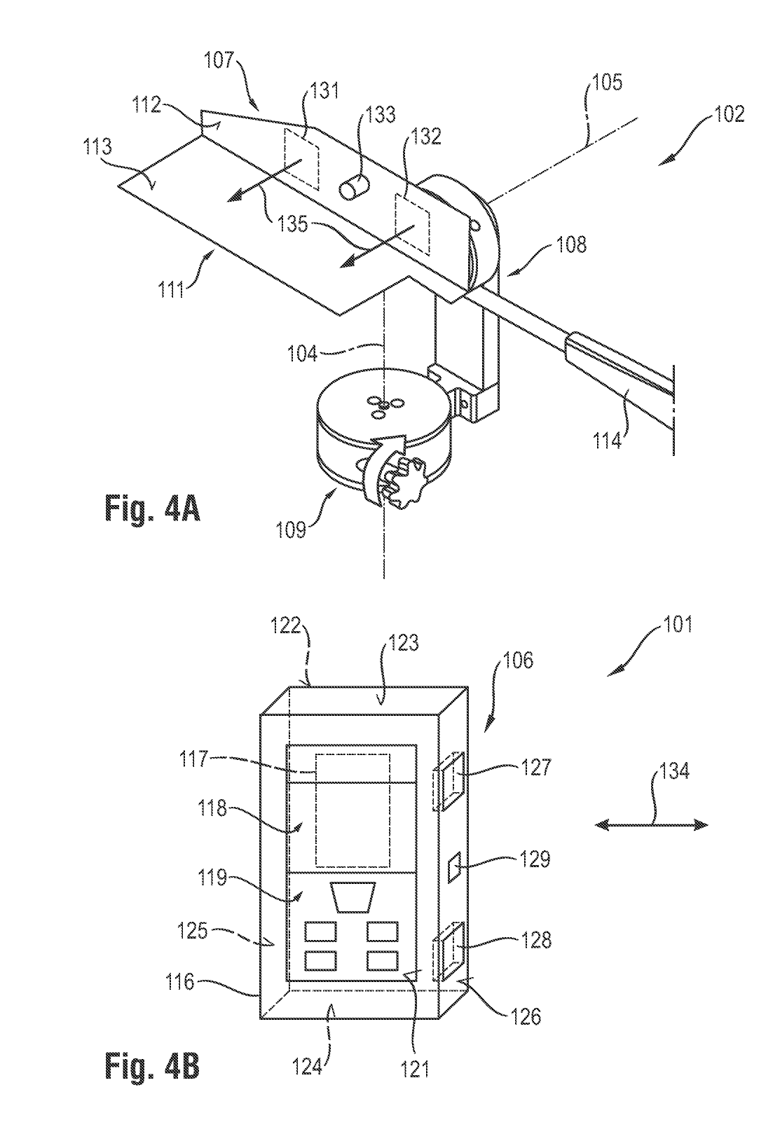

FIGS. 4A, 4B show the structure of the holding fixture 102 according to the invention (FIG. 4A) and the structure of the laser distance-measuring device 101 according to the invention (FIG. 4B) in detail. The laser distance-measuring device 101 is connected to the holding fixture 102 by means of a first connection means 106 as well as a second connection means 107.

The holding fixture 102 of the device system 100 is configured as a tripod adapter (FIG. 4A) with which a laser device, like the laser distance-measuring device 101, can be attached to the tripod 103. The tripod adapter 102 comprises a base element configured as a tripod head 108, an attachment means 109 to attach the tripod adapter 102 to the tripod 103, and the second connection means 107 to connect the tripod adapter 102 to the laser distance-measuring device 101. The attachment means 109 is configured as a threaded hole that, together with a threaded bolt of the tripod 103, forms a threaded connection.

The laser distance-measuring device 101 is connected via the tripod adapter 102 to the tripod 103 and is configured so as to be movable around the vertical rotational axis 104 and around the horizontal tilting axis 105 with respect to the tripod 103. The tripod head 108 has a receiving element 111 with a first and a second receiving surface 112, 113. The receiving element 111 can be adjusted around the tilting axis 105 by means of a handle 114.

The inventive laser device according of the device system 100 is configured as a laser distance-measuring device 101 with which the distance of a target point is measured (FIG. 4B). The laser distance-measuring device 101 comprises a device housing 116, a measuring apparatus 117 arranged in the device housing 116 and the first connection means 106 that is connected to the device housing 116 and that serves to connect the laser distance-measuring device 101 to the tripod adapter 102; in addition, the laser distance-measuring device 101 comprises a display unit 118 and an operating unit 119. The device housing 116 has a front surface 121, a rear surface 122 that is located opposite from the front surface, a top 123, a bottom 124 that is located opposite from the top, and two side surfaces 125, 126.

The display unit and the operating units 118, 119 are embedded into the front surface 121 of the device housing 116. In order to make it very convenient for the user to operate the laser distance-measuring device 101 as well as to ensure that the distance value is displayed, the front surface 121 and the rear surface 122 are the two largest surfaces of the device housing 116, which has a longer side (length) and a shorter side (width). The top and the bottom 123, 124 that adjoin the front surface 121 as well as the side surfaces 125, 126 of the device housing 116 are configured so as to be as small as possible in order to yield a convenient laser distance-measuring device 101. The two side surfaces 125, 126 adjoin the longer side of the front surface 121 and are defined by the length and the depth of the device housing 116.

The laser distance-measuring device 101 and the holding fixture 102 are connected by means of the first and second connection means 106, 107. The first connection means 106 of the laser distance-measuring device 101 comprises two first magnetic connection elements configured as ferromagnetic adhesion elements 127, 128, and a first plug-in element 129 configured as a socket. The second connection means 107 of the tripod adapter 102 has two second magnetic connection elements configured as permanent magnets 131, 132, and a second plug-in element configured as a plug 133. When the first and second first plug-in elements 129, 133 are in the connected state, they form the plug-and-socket connection, while the first and second magnetic connection elements 127, 128, 131, 132 form the magnetic connection.

The laser distance-measuring device 101 is moved together with the socket 129 along a plugging direction 134 over the plug 133 that is configured so as to mate with the socket 129, until the side surface 126 comes to rest against the receiving surface 112. The permanent magnets 131, 132 are configured as cuboids with a square base and a given height, and they have an axial magnetization vertically along a magnetization direction 135. The connection elements 131-133 of the second connection means 107 are arranged in such a way that the magnetization direction 135 of the permanent magnets 131, 132 runs parallel to the plugging direction 134 of the plug-in elements. The maximum force of the magnetic connection between the magnetic connection elements 127, 128, 131, 132 is present when the plug-and-socket connection is established and the side surface 126 of the device housing 116 comes to rest against the receiving surface 112 of the receiving element 111. The side surface 126 and the receiving surface 112 are designated as the first contact surface of the laser device 101 and the second contact surface of the holding fixture 102.

As shown in FIG. 4B, the first connection means 106 can be arranged in the side surface 126 of the device housing 116 or, alternatively, in the rear surface 122 of the device housing 116. The second connection means 107 is arranged analogously to the first connection means 106, either in the first receiving surface 112 that is located opposite from the side surface 126 or else in the second receiving surface 113 that is located opposite from the rear surface 122.

The holding fixture 102 according to the invention shown in detail in FIG. 4A is configured as a tripod adapter. If the adjustment of the base element 108 is limited to a pivoting movement around the tilting axis 105 and if a conventional clamping means such as, for instance, the attachment means 26 of FIG. 1 is used as the attachment means, one obtains a holding fixture configured as a plumb rod adapter for attaching laser devices.

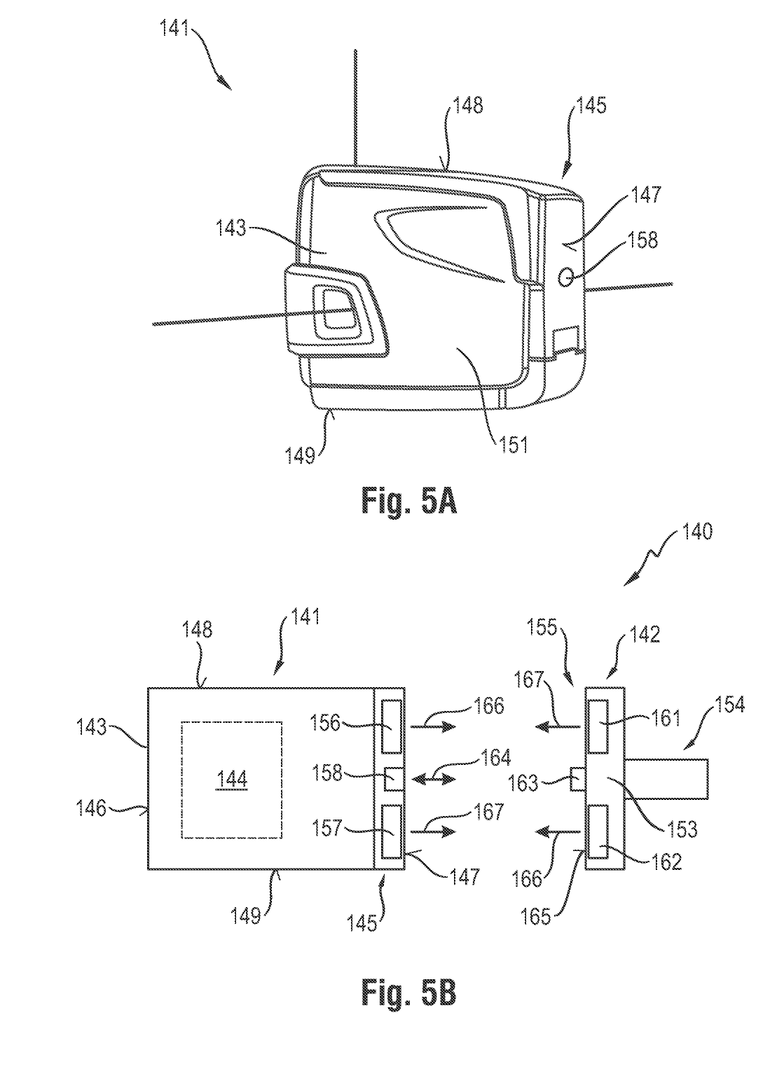

FIGS. 5A, 5B show a fourth embodiment of a device system 140 according to the invention, consisting of a point laser device 141 according to the invention and a holding fixture 142 according to the invention for attaching the point laser device 141 to an elongated holding element, for example, the surveyor's staff 13 shown in FIG. 1. In this context, FIG. 5A shows the point laser device 141 in a three-dimensional view and FIG. 5B shows a schematic view of the point laser device 141 and the holding fixture 142 in an unconnected state.

The inventive laser device of the device system 140 is configured as a self-leveling point laser device 141 with which the point beams are generated (FIG. 5A). The point laser device 141 comprises a device housing 143, a measuring apparatus 144 and a first connection means 145 that is connected to the device housing 143 and that connects the point laser device 141 to the holding fixture 142. The measuring apparatus 144 is arranged inside the device housing 143. The device housing 143 has a front surface 146, a rear surface 147 that is located opposite from the front surface 146, a top 148, a bottom 149 that is located opposite from the top 148, and two side surfaces 151, 152.

The holding fixture 142 comprises a base element 153, an attachment means 154 for attaching the holding fixture 142 to the holding element, and a second connection means 155 for connecting the holding fixture 142 to the point laser device 141. The attachment means 154 can be configured analogously to the attachment means 42 of the holding fixture 12 as a clamping means equipped with flat or V-shaped clamping jaws, which are adjusted by means of the adjustment element 44 until the clamping jaws are in contact with the side surfaces of the holding element. As an alternative, it is possible to use any known attachment means that are suitable for attaching the holding fixture to a holding element.

The point laser device 141 and the holding fixture 142 are connected by means of the first and second connection means 145, 155. The first connection means 145 of the point laser device 141 comprises two first magnetic connection elements configured as permanent magnets 156, 157, and a first plug-in element configured as a socket 158. The second connection means 155 of the holding fixture 142 has two second magnetic connection elements configured as permanent magnets 161, 162, and a second plug-in element 163 configured as a plug. When the first and second magnetic connection elements 156, 157, 161, 162 are in the connected state, they form the magnetic connection, while the first and second plug-in elements 158, 163 form the plug-and-socket connection.

The first plug-in elements are configured as cylindrical plugs 163 having a circular cross-sectional surface and as mating sockets 158; the plugging direction 164 runs parallel to cylinder axis of the plug-in elements. The point laser device 141 is moved together with the socket 158 along the plugging direction 164 over the plug 163 until the rear surface 147 of the device housing 143 comes to rest against a front 165 of the base element 153. The rear surface 147 of the device housing 143 is adapted to the front 165 of the base element 153. The rear surface 147 of the device housing 143 and the front 165 of the base element 153 are designated as the first contact surface of the laser device 141 and the second contact surface of the holding fixture 142.

The permanent magnets 156, 157 of the first connection means 145 and the permanent magnets 161, 162 of the second connection means 155 are each configured as cylindrical permanent magnets with an axial magnetization, that is to say, the poles of the permanent magnets are arranged on the base and top surfaces. In order to attach the point laser device 141 to the holding fixture 142, opposing poles have to be opposite from each other. The permanent magnets 156, 162 have a first magnetization direction 166 while the permanent magnets 157, 161 have a second magnetization direction 167, whereby the second magnetization direction 167 is opposite from the first magnetization direction 166.

The magnetization directions 166, 167 of the permanent magnets 156, 157, 161, 162 run parallel to the plugging direction 165. The maximum force of the magnetic connection between the permanent magnets 156, 157, 161, 162 is present when the rear surface 147 of the device housing 143 comes to rest against the front surface 165 of the base element 153 and the plug-and-socket connection is established. The arrangement of the permanent magnets 156, 157, 161, 162 shown in FIG. 5B has the advantage that the permanent magnets only attract in the desired orientation; if the holding fixture 142 is inserted into the socket in a way that is rotated by 180°, the same poles are opposite from each other and the permanent magnets 156, 157 of the point laser device 141 repel the permanent magnets 161, 162 of the holding fixture 142.

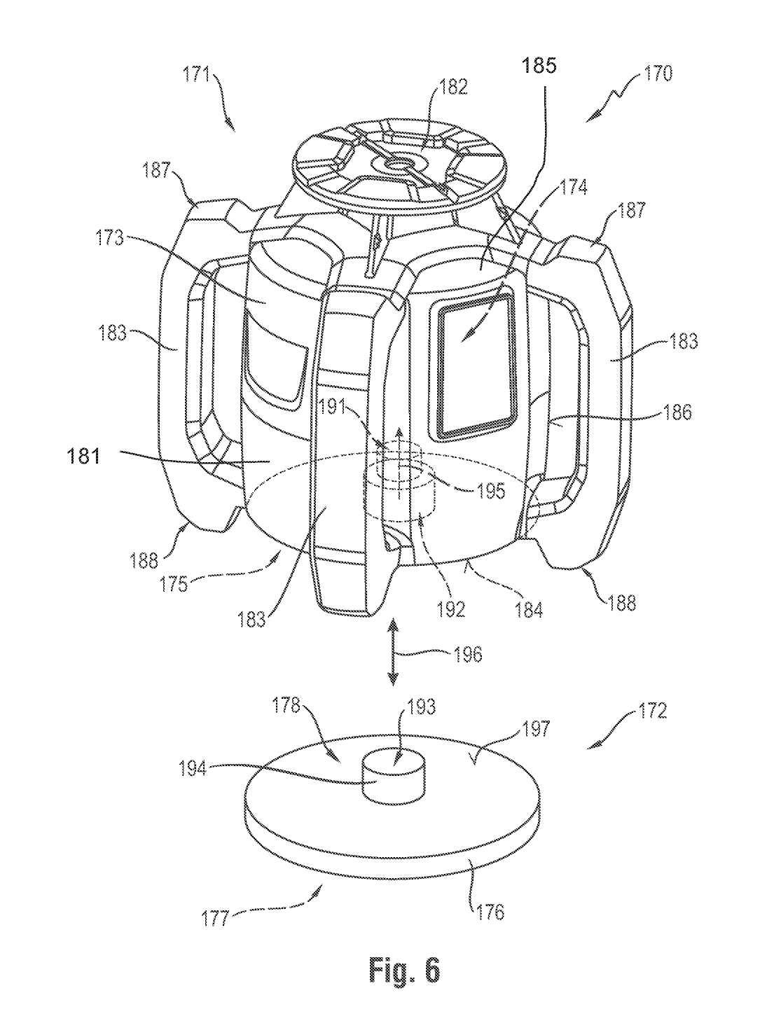

FIG. 6 shows a fifth embodiment of the device system 170 according to the invention, comprising a rotary laser device 171 and a holding fixture 172 for attaching the rotary laser device 171 to a tripod.

The inventive laser device of the device system 170 is configured as a rotary laser device 171 with which a line beam can be generated. The rotary laser device 171 comprises a device housing 173, a measuring apparatus 174 that is arranged inside the device housing 173 and a first connection means 175 that is connected to the device housing 173 and that serves to connect the rotary laser device 171 to the holding fixture 172.

The holding fixture 172 comprises a base element 176, an attachment means 177 for attaching the holding fixture 172 to the tripod and a second connection means 178 to connect the holding fixture 172 to the rotary laser device 171. The attachment means 177 is configured as a threaded hole that, together with a threaded bolt 21 of the tripod, forms a threaded connection. A detachable holding fixture 172 can be attached to any conventional tripod with threaded bolts, so that any conventional tripod can be retrofitted. As an alternative, the holding fixture 172 can be integrated into a tripod; in this case, the base element 176 corresponds to the plate of the tripod.

The device housing 173 of the rotary laser device 171 comprises a base housing 181, a rotary head 182 and several handles 183. The base housing 181 consists of a base surface 184, a top surface 185 that is located opposite from the base surface 184 and a side surface 186 that connects the base and top surfaces 184, 185. The rotary head 182 is connected on the top surface 185 to the base housing 181 and the handles 183 are attached to the base housing 181. The handles 183 have an upper shock-absorbing element 187 on an upper end facing the rotary head 182, and a lower shock-absorbing element 188 on a lower end facing the base surface 184. If the rotary laser device 171 falls or is struck, the shock-absorbing elements 187, 188 improve the energy absorption and energy dissipation into the handles 183.

The rotary laser device 171 and the holding fixture 172 are connected by means of the first and second connection means 175, 178. The first connection means 175 of the rotary laser device 171 comprises a first magnetic connection element 191 configured as a permanent magnet, and a first plug-in element 192 configured as a socket. The second connection means 178 of the holding fixture 172 comprises a second magnetic connection element 193 as well as a second plug-in element 194 configured as a plug. The permanent magnet 191 has a cylindrical shape in the form of a disc having a given diameter and height, and it has an axial magnetization along a magnetization direction 195. The plug 194 is configured as a circular cylinder made of a ferromagnetic material and it concurrently forms the second magnetic connection element 193.

The rotary laser device 171 is moved together with the socket 192 along a plugging surface 196 over the plug 194 until the base surface 181 of the base housing 181 comes to rest against the top 197 of the base element 176. Since the permanent magnet 191 is axially magnetized along the magnetization direction 195 and since the axial distance between the magnetic connection elements 191, 193 is at its smallest when the plug-and-socket connection is established, the maximum force of the magnetic connection is present when the plug-and-socket connection of the plug-in elements 192, 194 is established and the base surface 181 of the rotary laser device 171 comes to rest against the base element 176. When in the connected state, the magnetic connection between the magnetic connection elements 191, 193 affixes the arrangement of the plug-in elements 192, 194 in the established plug-and-socket connection. The magnetization direction 195 of the permanent magnet 191 runs parallel to plugging direction 196 of the plug-and-socket connection. Since the maximum force of the magnetic connection is present when the plug-and-socket connection is established, it is ensured that, when the rotary laser device 171 and the holding fixture 172 are in the connected state, they have a defined and reproducible arrangement.

The plug-in element 194 configured as a plug is made of a ferromagnetic material and the second magnetic connection element 193 is integrated into the plug 194; the disc magnet 191 is arranged behind the socket 192. The physical separation of the permanent magnet 191 from the socket 192 has the advantage that the permanent magnet 191 is not mechanically stressed when the plug-and-socket connection is being severed and established. Moreover, the permanent magnet 191 is protected against corrosion, which is especially important when neodymium magnets are used.

The first and second connection means 175, 178 each have a plug-in element 192, 194. The socket 192 and the plug 194 are configured with a cylindrical shape so that when the rotary laser device 171 is in the connected state, it is configured so that it can be rotated around a rotational axis that runs coaxially to the plugging direction 196. If rotatability is not desired, the plug-in elements 192, 194 have a non-rotation-symmetrical cross section perpendicular to the plugging direction 196. Moreover, the second magnetic connection element 193 and the second plug-in element 194 can be configured as separate elements. Instead of the cylindrical permanent magnet 191, it is possible to use, for instance, a spherical permanent magnet or a horseshoe magnet. The shape of the permanent magnet 191 is adapted to the circumstances of the laser device 171 and to the space available.

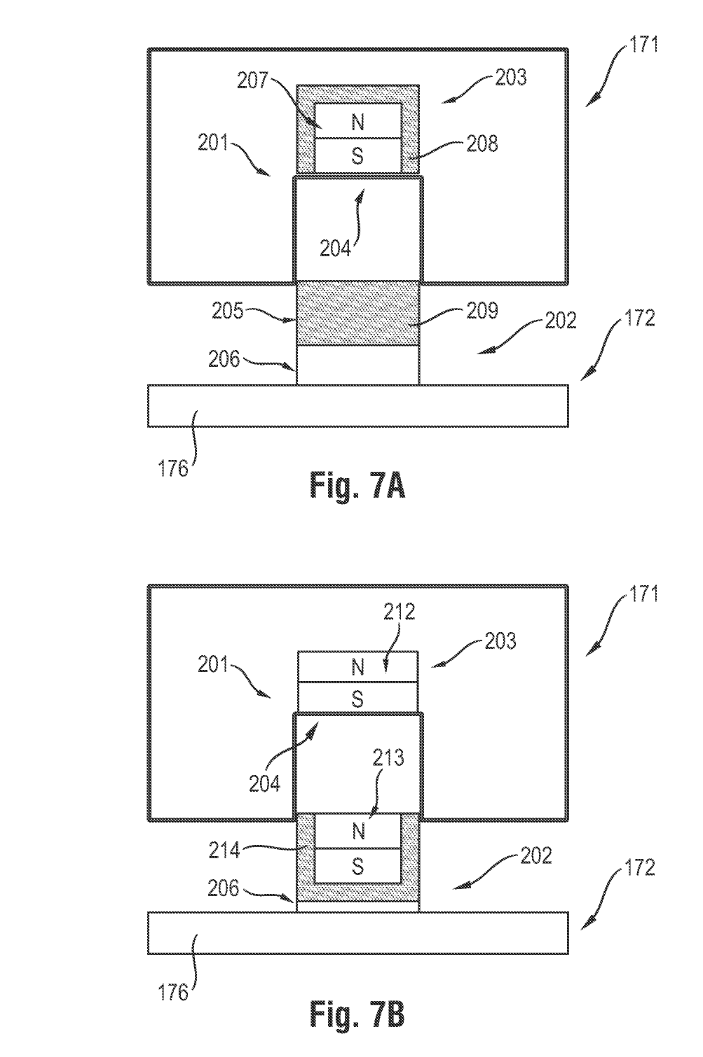

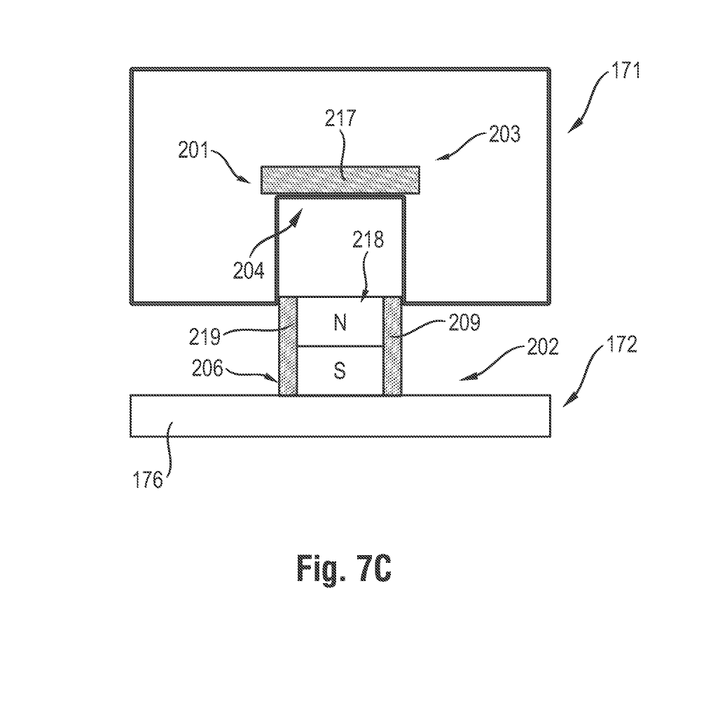

FIGS. 7A-7C show three different variants of a plug-and-socket connection and a magnetic connection in the example of the device system 170 having the rotary laser device 171 and the holding fixture 172.

The rotary laser device 171 is connected to the holding fixture 172 by means of a first connection means 201 and a second connection means 202. The first connection means 201 of the rotary laser device 171 has a first magnetic connection element 203 and a first plug-in element configured as a socket 204. The second connection means 202 of the holding fixture 172 has a second magnetic connection element 205 and a second plug-in element configured as a plug 206. The plug 206 and the mating socket 204 can be configured analogously to the plug-in elements 194, 192.

FIG. 7A shows a variant of the plug-and-socket connection and of the magnetic connection between the first and second connection means 201, 202. The first magnetic connection element 203 has a permanent magnet 207 and an additional ferromagnetic element 208 that surrounds the permanent magnet. The second magnetic connection element 205 is configured as a ferromagnetic holding element 209 and is integrated into the plug 206. The ferromagnetic element is configured as a steel pot 208 that changes the magnetic field of the permanent magnet 207. The magnetic field lines are aimed at the adhesion element 209 and the adhesive force of the magnetic connection is strengthened. The shape of the ferromagnetic element 208 is adapted to the shape of the permanent magnet 207.

FIG. 7B shows a second variant of the plug-and-socket connection and of the magnetic connection between the first and second connection means 201, 202. The first magnetic connection element 203 is configured as permanent magnet 212 and the second magnetic connection element 205 has a permanent magnet 213 and an additional ferromagnetic element 214 that surrounds the permanent magnet 213.

FIG. 7C shows a third variant of the plug-and-socket connection and of the magnetic connection between the first and second connection means 201, 202. The first magnetic connection element 203 is configured as ferromagnetic adhesion element 217 and the second magnetic connection element 205 has a permanent magnet 218 and an additional ferromagnetic element 219 that surrounds the permanent magnet 218.

The connection means 201, 202 shown in FIGS. 7A-7C can be employed not only with the device system 170 having the rotary laser device 171 and the holding fixture 172 but also with the device systems 10, 60, 100, 140. The first or second magnetic connection elements configured as permanent magnets can be replaced, for example, by magnetic connection elements that, aside from the permanent magnet, also have an additional ferromagnetic element. Moreover, the magnetic connection elements and/or plug-in elements can be exchanged in every device system.

What is claimed is:

1-18. (canceled)

19. A laser device comprising:
a device housing;
a measurer at least partially arranged inside the device housing; and
a first connector connected to the device housing and serving to connect the laser device to a holding fixture, the first connector having a first magnetic connection element and a first plug-in element.

20. The laser device as recited in claim 19 wherein the first plug-in element is a socket.

21. The laser device as recited in claim 19 wherein the first magnetic connection element includes a permanent magnet.

22. The laser device as recited in claim 21 wherein the permanent magnet is a cylindrical permanent magnet or a spherical permanent magnet, poles of the permanent magnet being arranged parallel to a plugging direction of the first plug-in element.

23. The laser device as recited in claim 21 wherein the first magnetic connection element additionally has a ferromagnetic or ferrimagnetic element.

24. The laser device as recited in claim 10 wherein the first magnetic connection element is configured as a ferromagnetic or ferrimagnetic adhesion element.

25. The laser device as recited in claim 19 wherein the first connector has a further first magnetic connection element or a further first plug-in element.

26. The laser device as recited in claim 19 wherein the device housing includes a base housing and a protective housing surrounding the base housing, the first connector being arranged in the protective housing.

27. The laser device as recited in claim 19 wherein the device housing is configured in one part.

28. A holding fixture for attaching a laser device to a holding element, the holding fixture comprising:
a base element;
an attachment connected to the base element and serving to attach the holding fixture to the holding element; and
a second connector connected to the base element and serving to connect the holding fixture to the laser device, the second connector having a second magnetic connection element and a second plug-in element.

29. The holding fixture as recited in claim 28 wherein the second plug-in element is configured as a plug.

30. The holding fixture as recited in claim 28 wherein the second magnetic connection element is configured as a ferromagnetic or ferrimagnetic adhesion element.

31. The holding fixture as recited in claim 28 wherein the second magnetic connection element includes a permanent magnet.

32. The holding fixture as recited in claim 31 wherein the second magnetic connection element additionally has a ferromagnetic or ferrimagnetic element.

33. The holding fixture as recited in claim 31 wherein the second connector has a further second magnetic connection element or further second plug-in element.

34. A device system comprising:
a laser device including a housing, a measurer and a first connector; and
a holding fixture for attaching the laser device to a holding element, the holding fixture including a base element, an attachment for attaching the holding fixture to the holding element, and a second connector;
the first connector having a first magnetic connection element and a first plug-in element, and the second connector having a second magnetic connection element and a second plug-in element, the first and second plug-in elements, when connected, forming a plug-and-socket connection, while the first and second magnetic connection elements form a magnetic connection.

35. The device system as recited in claim 34 wherein a maximum force of the magnetic connection between the first and second magnetic connection elements is present when the plug-and-socket connection between the plug-in elements is established.

36. The device system as recited in claim 35 wherein, when the plug-and-socket connection is established, the first and second connectors connect a first contact surface of the laser device to a second contact surface of the holding fixture.
